(19) United States
(12) Patent Application Publication
(10) Pub. No.: US 2022/0113580 A1
(43) Pub. Date: Apr. 14, 2022

(54) DISPLAY DEVICE

(71) Applicant: SHARP KABUSHIKI KAISHA, Sakai City (JP)

(72) Inventors: TATSUYA TERASHIMA, Sakai City (JP); MASATERU UEKI, Sakai City (JP)

(21) Appl. No.: 17/491,236

(22) Filed: Sep. 30, 2021

(30) Foreign Application Priority Data
Oct. 12, 2020 (JP) 2020-171966
May 13, 2021 (JP) 2021-081720

(51) Int. Cl. G02F 1/1333

(52) U.S. Cl. CPC G02F 1/133308

(57) ABSTRACT

A display device includes a display panel and a frame disposed along an outer edge of the display panel. The frame has a first inclined face, of which a normal direction points to a rear face side of the display panel, at a position facing an end face of the display panel.

### BACKGROUND

### 1. Field

The present disclosure relates to a display device.

### 2. Description of the Related Art

In various types of display devices including television receivers, innovations are being made in recent years to suppress light from leaking out from between a liquid crystal panel and a frame.

Japanese Unexamined Patent Application Publication No. 2010-223999 (published Oct. 7, 2010) discloses a liquid crystal display device. FIGS. 13 and 14 are cross-sectional views of a liquid crystal display device 200 according to the related art, in which features of the disclosure in Japanese Unexamined Patent Application Publication No. 2010-223999 are extracted. As illustrated in FIG. 13, in the liquid crystal display device 200 according to Japanese Unexamined Patent Application Publication No. 2010-223999, a substrate 21 of a liquid crystal display panel 2 and a side face 1061 of a frame 106 are bonded to each other by light shielding double-sided tape 4 that has light-shielding properties. Light emitted from a backlight 6 and passing through a diffusion plate 7 and an optical sheet 8 is reflected by the light shielding double-sided tape 4, and accordingly does not travel to the front face of the liquid crystal display panel 2.

However, as illustrated in FIG. 14, there is a problem in the above liquid crystal display device 200, in that light passing through a polarizing plate 24, traveling through the inside of the liquid crystal display panel 2, and leaking out from an end face 23 of the liquid crystal display panel 2 is reflected at a side face 1062, and travels to the front face side. Note that while FIG. 14 illustrates light passing through the rear face side of the panel interior, there also is light that passes through the front face side of the panel interior and leaks out from the end face 23.

It is desirable to suppress light leaking from an end face of a display panel from traveling to the front face side.

### SUMMARY

According to an aspect of the present disclosure, there is provided a display device including a display panel and a frame disposed along an outer edge of the display panel. The frame has a first inclined face, of which a normal direction points to a rear face side of the display panel, at a position facing an end face of the display panel.

### BRIEF DESCRIPTION OF THE DRAWINGS

FIG. 1 is a front view illustrating an external appearance of a display device according to Embodiment 1 of the present disclosure;

FIG. 2 is an enlarged view of a corner portion of the display device illustrated in FIG. 1;

FIG. 3 is a perspective view illustrating the external appearance of the display device illustrated in FIG. 1;

FIG. 4 is an enlarged view of the corner portion of the display device illustrated in FIG. 3;

FIG. 5 is a cross-sectional view illustrating a display device using a frame according to Embodiment 1 of the present disclosure, taken along cross-sectional line V-V in FIG. 1;

FIG. 6 is a cross-sectional view illustrating a display device using a frame according to Modification 1, taken along cross-sectional line VI-VI in FIG. 1;

FIG. 7 is a cross-sectional view illustrating a display device using a frame according to Modification 2, taken along cross-sectional line VII-VII in FIG. 1;

FIG. 8 is a cross-sectional view illustrating a display device using a frame according to Modification 3, taken along cross-sectional line VIII-VIII in FIG. 1;

FIG. 9 is a cross-sectional view illustrating a display device using a frame according to Modification 4, taken along cross-sectional line IX-IX in FIG. 1;

FIG. 10 is a cross-sectional view illustrating the display device using the frame according to Modification 1, taken along cross-sectional line X-X in FIG. 1;

FIG. 11 is a cross-sectional view illustrating a display device using a frame according to Modification 5, taken along cross-sectional line XI-XI in FIG. 1;

FIG. 12 is a cross-sectional view illustrating the display device using the frame according to Modification 5, taken along cross-sectional line XII-XII in FIG. 1;

FIG. 13 is a cross-sectional view illustrating a display device using a frame according to the related art, taken along cross-sectional line XIII-XIII in FIG. 1; and

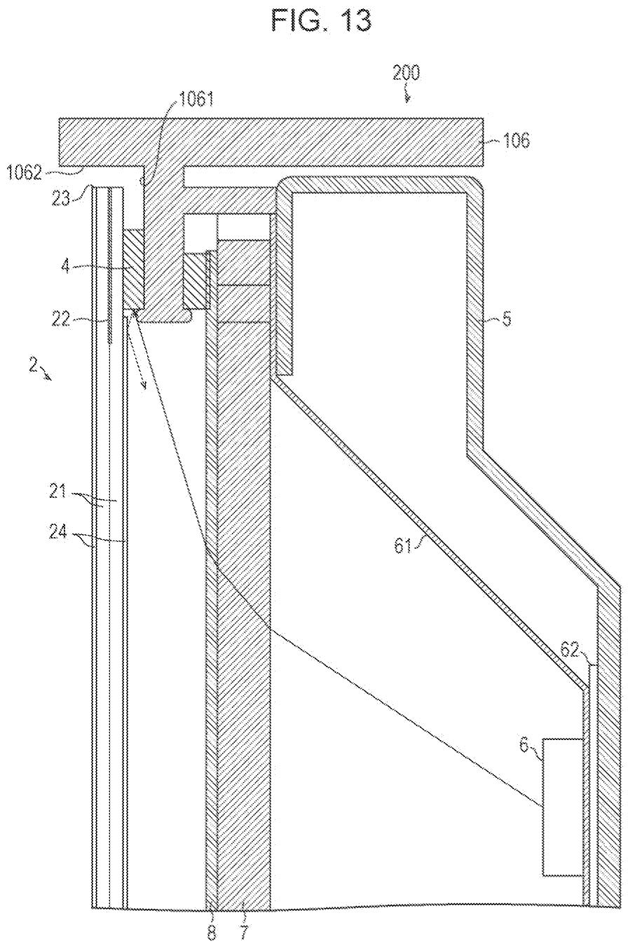

FIG. 14 is a cross-sectional view illustrating the display device using the frame according to the related art, taken along cross-sectional line XIV-XIV in FIG. 1.

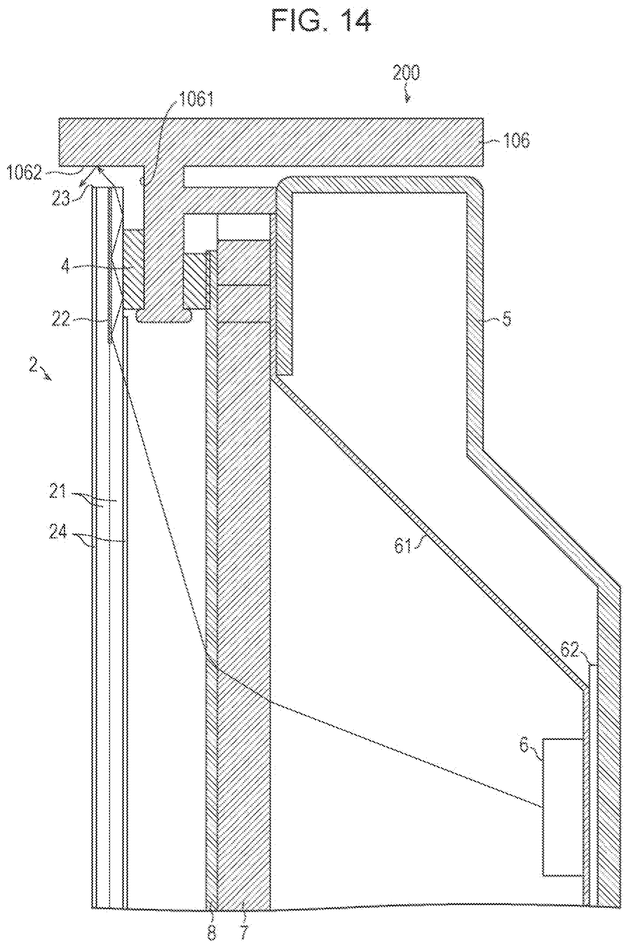

### DESCRIPTION OF THE EMBODIMENTS

### Embodiment 1

A display device 100 according to Embodiment 1 of the present disclosure will be described below in detail.

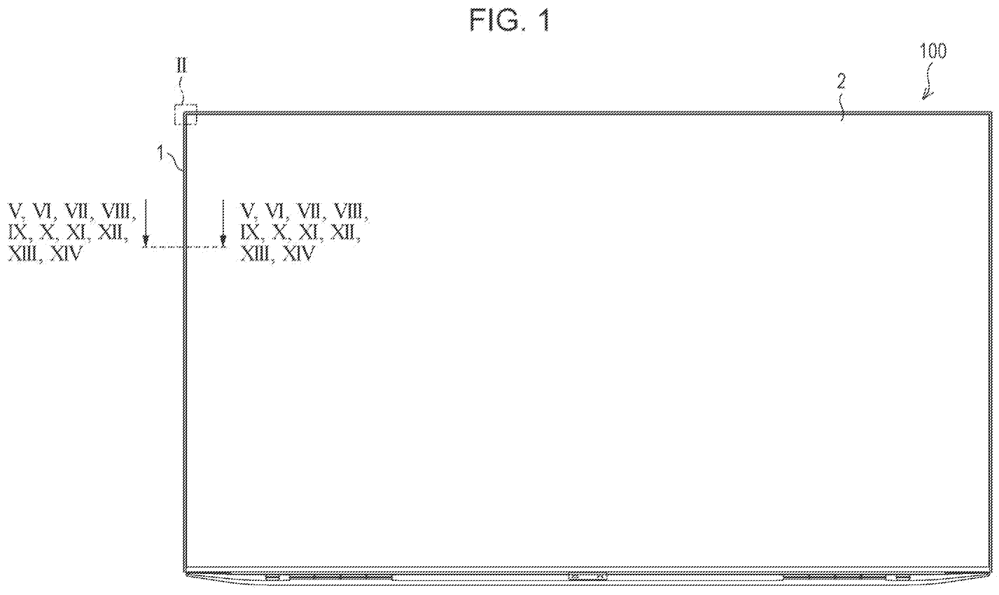

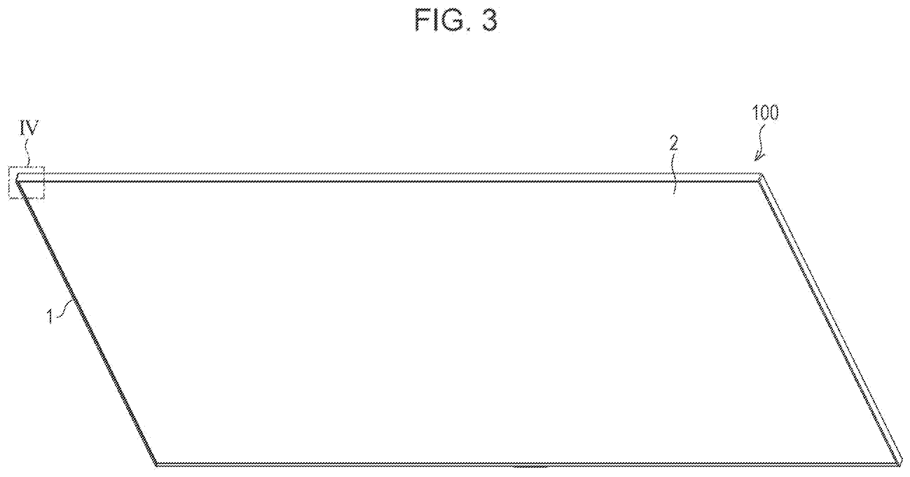

FIG. 1 is a front view illustrating an external appearance of the display device 100 according to the present embodiment. FIG. 3 is a perspective view illustrating the external appearance of the display device 100 according to the present embodiment. The display device 100 is a television receiver, for example. As illustrated in FIGS. 1 and 3, the display device 100 includes a frame 1 and a display panel 2. The frame 1 is disposed along an outer edge of the display panel 2. The display panel 2 is a panel that displays images, an example of which is a liquid crystal display panel.

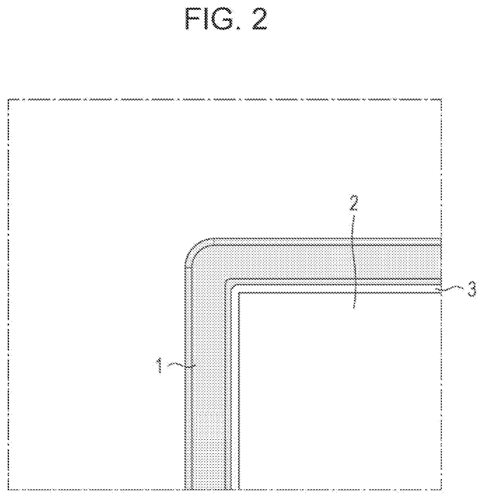

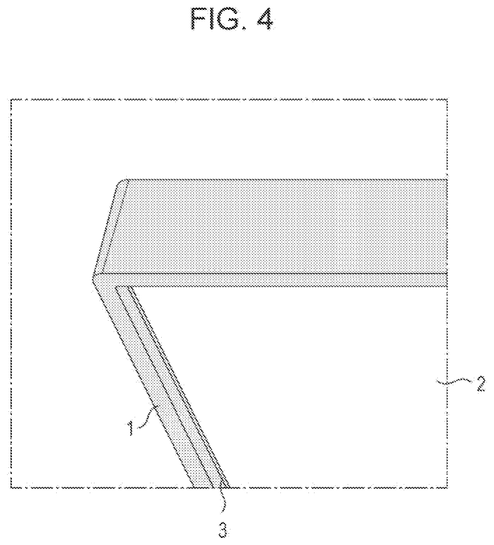

FIG. 2 is a front view in which a corner portion II in FIG. 1 is enlarged. FIG. 4 is a perspective view in which a corner portion IV in FIG. 3 is enlarged. As illustrated in FIGS. 2 and 4, there is a gap 3 between the frame 1 and the display panel 2. Accordingly, there is room for light exiting an edge face of the display panel 2 to leak out to a front face side of the display panel 2 through the gap 3.

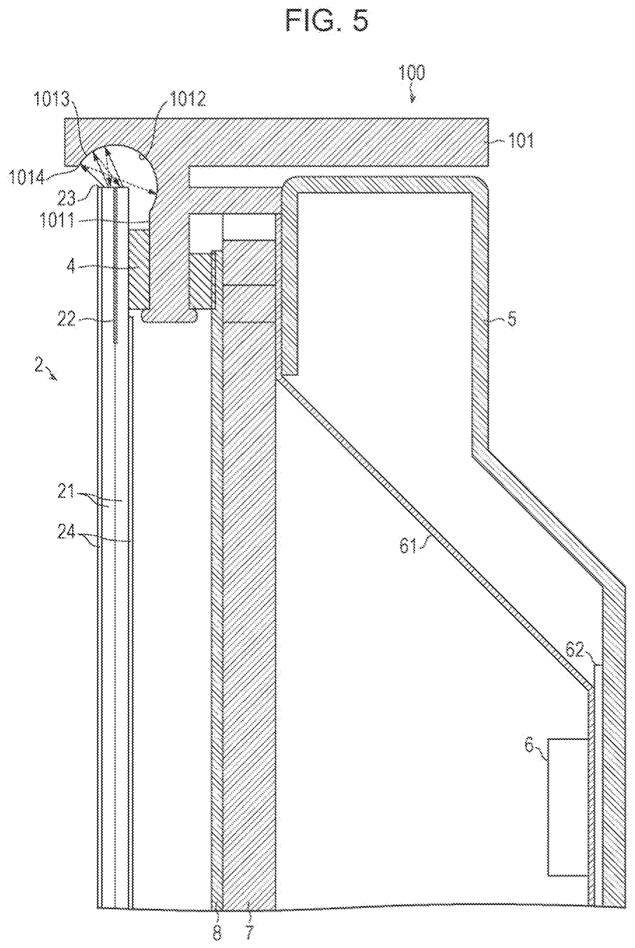

FIG. 5 is a cross-sectional view of a display device 100 using a frame 101 according to the present embodiment. In detail, FIG. 5 is a cross-sectional view of the frame 101 and the surroundings thereof, taken along cross-sectional line V-V (dashed line) in FIG. 1. As illustrated in FIG. 5, the display device 100 includes the frame 101, the display panel 2, a backlight chassis 5, a backlight 6, a diffusion plate 7, and an optical sheet 8.

The frame 101 is configured to surround the perimeter of the display panel 2 and the backlight chassis 5. The display panel 2 is made up of two substrates 21. A black matrix 22 is disposed between the substrates 21, and a polarizing plate 24 is disposed on the outer side of each substrate 21. The black matrix 22 has wiring therein, and also functions as a liquid crystal sealant. The polarizing plates 24 have layered structures, and transmit only light waves in a certain vibration direction.

The backlight 6 is disposed on a rear face side of the display panel 2. A reflecting sheet 61 is attached to a rear face side of the backlight 6. A backlight substrate 62 is attached to a rear face side of the reflecting sheet 61.

The reflecting sheet 61 is installed at portions other than a portion where a light source of the backlight 6 is disposed, and has the function of reflecting light from the light source. The backlight substrate 62 is attached to the front face side of the backlight chassis 5. The backlight 6, the reflecting sheet 61, and the backlight substrate 62 are supported by the backlight chassis 5.

Light-emitting diodes (LEDs) may be used for the backlight 6. The backlight 6 casts light toward the display panel 2. The diffusion plate 7 and the optical sheet 8 are provided at the front face side of the backlight 6. The diffusion plate 7 diffuses light from the backlight 6. The optical sheet 8 includes a diffusion sheet, a prism sheet, a microlens sheet, and so forth.

Note that the front face side is the display screen side of the display panel 2, that is, faces leftward in FIG. 5. The rear face side is the opposite side from the display screen side of the display panel 2, that is, faces rightward in FIG. 5.

Frame 101

The frame 101 has a first side face 1011 and a second side face 1012. The first side face 1011 is parallel to the faces of the display panel 2, and is formed so as to face the substrate 21 on the rear face side of the display panel 2. The substrate 21 on the rear face side and the first side face 1011 of the frame 101 are bonded by light shielding double-sided tape 4.

The second side face 1012 is formed at a position facing an end face 23 of the display panel 2, and may have a structure of a cylindrical inner face of which a center axis is on the end face 23, for example. The second side face 1012 has a first inclined face 1013 at the front face side of the display device 100. The first inclined face 1013 is an inclined face of which the normal direction points toward the rear face side of the display panel 2 at a position facing the end face 23 of the display panel 2. Also, the first inclined face 1013 may be a curved inclined face, formed as a recessed portion in the frame 101.

Note that the first inclined face 1013 may be formed as a protruding portion in the frame 101.

In FIG. 5, solid line arrows represent light leaking from the end face 23, and dotted line arrows represent light reflected by the first inclined face 1013. Light leaking from the end face 23 is reflected toward the rear face side of the display panel 2 by the first inclined face 1013. Because the frame 101 has a configuration including the first inclined face 1013, the frame 101 can suppress light from reflecting to the front face side of the display panel 2, and light can be suppressed from leaking out from between the display panel 2 and the frame 101.

Note that the first inclined face 1013 of the frame 101 may be treated so as to attenuate primary reflected light. For example, the surface of the first inclined face 1013 of the frame 101 may be black. Thus, light from the end face 23 is absorbed, thereby increasing the effect of suppressing leakage of light from the end face 23.

The first inclined face 1013 may also be formed as a recessed portion, with an end portion 1014 of the first inclined face 1013 at the front face side of the display panel 2 being located further toward the front face side than the display panel 2. According to this configuration, even in a case in which shrinkage of the frame 101 occurs, the end face 23 of the display panel 2 does not come into contact with the frame 101, due to the recessed portion formed by the first inclined face 1013. Accordingly, damage to the display panel 2 arising from contact between the frame 101 and the display panel 2 can be suppressed. The term “shrinkage of the frame” here refers to shrinkage of the frame that occurs due to a change in temperature, for example. Particularly, there is concern of the entire frame shrinking due to a change in temperature in a case where the frame is made of a resin that exhibits a large amount of shrinkage due to a change in temperature, and accordingly the above-described configuration may be employed.

Modification 1

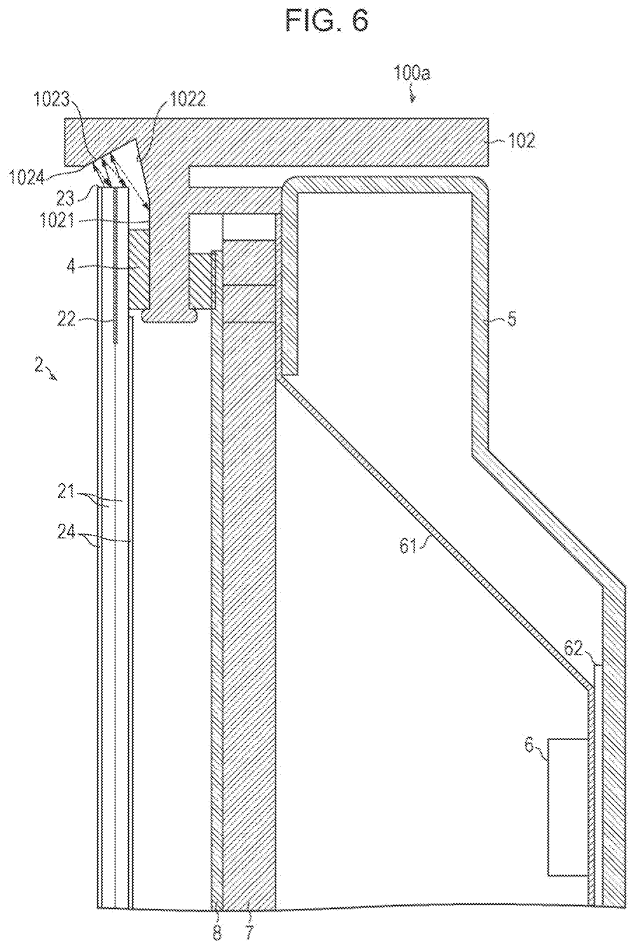

FIG. 6 is a cross-sectional view of a display device 100a that uses a frame 102 according to Modification 1. In detail, FIG. 6 is a cross-sectional view of the frame 102 and the surroundings thereof, taken along cross-sectional line VI-VI (dashed line) in FIG. 1. As illustrated in FIG. 6, the display device 100a includes the frame 102, the display panel 2, the backlight chassis 5, the backlight 6, the diffusion plate 7, and the optical sheet 8. Other than using the frame 102 according to Modification 1, the display device 100a has the same configuration as the display device 100 that uses the frame 101.

Frame 102

The frame 102 has a first side face 1021, a second side face 1022, and a third side face 1023. The first side face 1021 is parallel to the faces of the display panel 2, and is formed so as to face the substrate 21 on the rear face side of the display panel 2. The substrate 21 on the rear face side and the first side face 1021 of the frame 102 are bonded by the light shielding double-sided tape 4.

The second side face 1022 is a side face connecting the first side face 1021 and the third side face 1023, and is gently inclined with respect to the first side face 1021.

The third side face (first inclined face) 1023 is formed at a position facing the end face 23 of the display panel 2, and is an inclined face of which the normal direction points toward the rear face side of the display panel 2. Also, the third side face 1023 is a planar inclined face.

Note that the third side face 1023 may be formed as a recessed portion or may be formed as a protruding portion in the frame 102.

In FIG. 6, solid line arrows represent light leaking from the end face 23, and dotted line arrows represent light reflected by the third side face 1023. Light leaking from the end face 23 is reflected toward the rear face side of the display panel 2 by the third side face 1023. Because the frame 102 has a configuration including the third side face 1023, the frame 102 can suppress light from reflecting to the front face side of the display panel 2, and light can be suppressed from leaking out from between the display panel 2 and the frame 102.

Note that the third side face 1023 of the frame 102 may be treated so as to attenuate primary reflected light. For example, the surface of the third side face 1023 of the frame 102 may be black. Thus, light from the end face 23 is absorbed, thereby increasing the effect of suppressing leakage of light from the end face 23.

The third side face 1023 may also be formed as a recessed portion, with an end portion 1024 of the third side face 1023 at the front face side of the display panel 2 being located further toward the front face side than the display panel 2. According to this configuration, even in a case in which shrinkage of the frame 102 occurs, the end face 23 of the display panel 2 does not come into contact with the frame 102, due to the recessed portion formed by the third side face 1023. Accordingly, damage to the display panel 2 arising from contact between the frame 102 and the display panel 2 can be suppressed.

Modification 2

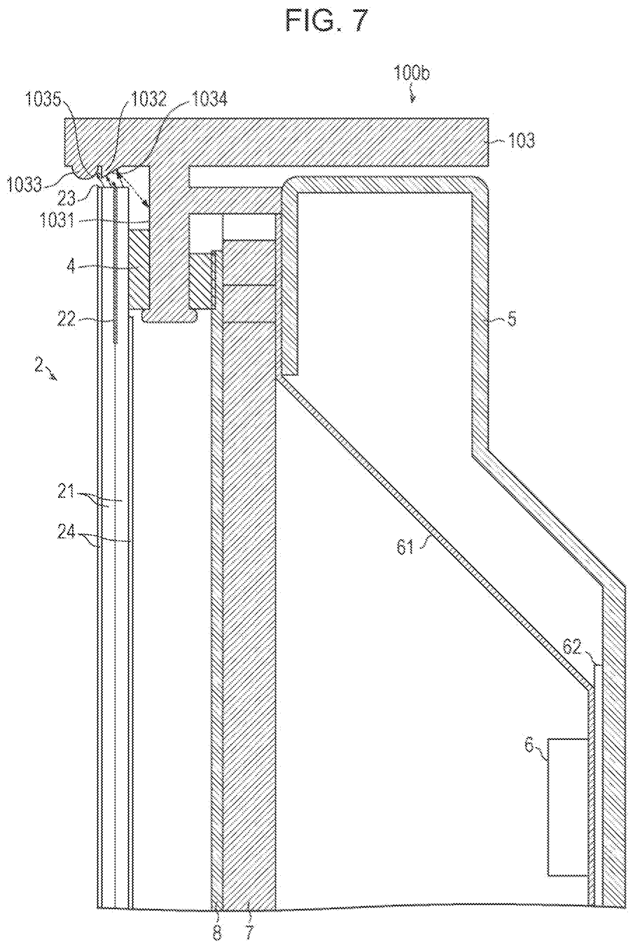

FIG. 7 is a cross-sectional view of a display device 100b that uses a frame 103 according to Modification 2. In detail, FIG. 7 is a cross-sectional view of the frame 103 and the surroundings thereof, taken along the cross-sectional line VII-VII (dashed line) in FIG. 1. As illustrated in FIG. 7, the display device 100b includes the frame 103, the backlight chassis 5, the backlight 6, the diffusion plate 7, and the optical sheet 8. Other than using the frame 103 according to Modification 2, the display device 100b has the same configuration as the display device 100 that uses the frame 101.

Frame 103

The frame 103 has a first side face 1031, a first protruding portion 1032, and a second protruding portion 1033. The first side face 1031 is parallel to the faces of the display panel 2, and is formed so as to face the substrate 21 on the rear face side of the display panel 2. The substrate 21 on the rear face side and the first side face 1031 of the frame 103 are bonded by the light shielding double-sided tape 4.

The first protruding portion 1032 is formed at a position facing the end face 23 of the display panel 2. A planar first inclined face A (inclined face) 1034 is formed on the first protruding portion 1032. The normal direction of the first inclined face A 1034 points toward the rear side of the display panel 2.

The second protruding portion 1033 is formed at a position facing the end face 23 of the display panel 2. A curved first inclined face B (inclined face) 1035 is formed on the second protruding portion 1033. The normal direction of the first inclined face B 1035 points toward the rear side of the display panel 2. The first inclined face B 1035 may be formed as a protruding portion. Also, the second protruding portion 1033 may be located further toward the front face side than the display panel 2.

Note that the first inclined face A 1034 and the first inclined face B 1035 may be formed as recessed portions in the frame 103.

In FIG. 7, solid line arrows represent light leaking from the end face 23, and dotted line arrows represent light reflected by the first inclined face A 1034 and the first inclined face B 1035. Light leaking from the end face 23 is reflected toward the rear face side of the display device 100b by the first inclined face A 1034 and the first inclined face B 1035. Accordingly, the frame 103 can suppress light from reflecting to the front face side of the display panel 2, and light can be suppressed from leaking out to the front face side of the display panel 2.

Note that the first inclined face A 1034 and the first inclined face B 1035 of the frame 103 may be treated so as to attenuate primary reflected light. For example, the surfaces of the first inclined face A 1034 and the first inclined face B 1035 of the frame 103 may be black. Thus, light from the end face 23 is absorbed, thereby increasing the effect of suppressing leakage of light from the end face 23.

Modification 3

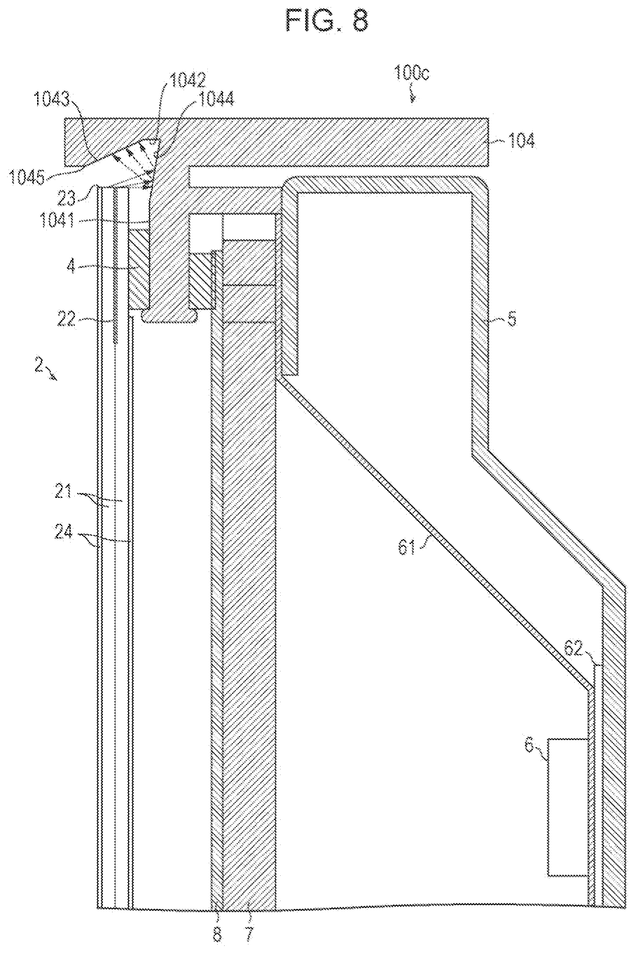

FIG. 8 is a cross-sectional view of a display device 100c that uses a frame 104 according to Modification 3. In detail, FIG. 8 is a cross-sectional view of the frame 104 and the surroundings thereof, taken along cross-sectional line VIII-VIII (dashed line) in FIG. 1. As illustrated in FIG. 8, the display device 100c includes the frame 104, the backlight chassis 5, the backlight 6, the diffusion plate 7, and the optical sheet 8. Other than using the frame 104 according to Modification 3, the display device 100c has the same configuration as the display device 100 that uses the frame 101.

Frame 104

The frame 104 has a first side face 1041, a second side face 1042, a third side face (first inclined face) 1043, and a fourth side face (second inclined face) 1044. The first side face 1041 is parallel to the faces of the display panel 2, and is formed so as to face the substrate 21 on the rear face side of the display panel 2. The substrate 21 on the rear face side and the first side face 1041 of the frame 104 are bonded by the light shielding double-sided tape 4.

The second side face 1042 is a side face connecting the third side face 1043 and the fourth side face 1044, and is parallel to the end face 23.

The third side face 1043 is formed at a position facing the end face 23 of the display panel 2, and is an inclined face of which the normal direction points toward the rear face side of the display panel 2. Also, the third side face 1043 is a planar inclined face.

The fourth side face 1044 is formed at the rear face side of the display panel 2, at a position away from the end face 23 of the display panel 2, and the normal direction thereof points toward the third side face 1043. Also, the fourth side face 1044 is a planar inclined face.

Note that the third side face 1043 may be formed as a recessed portion or may be formed as a protruding portion in the frame 104.

Also, the fourth side face 1044 may be formed as a recessed portion in the frame 104.

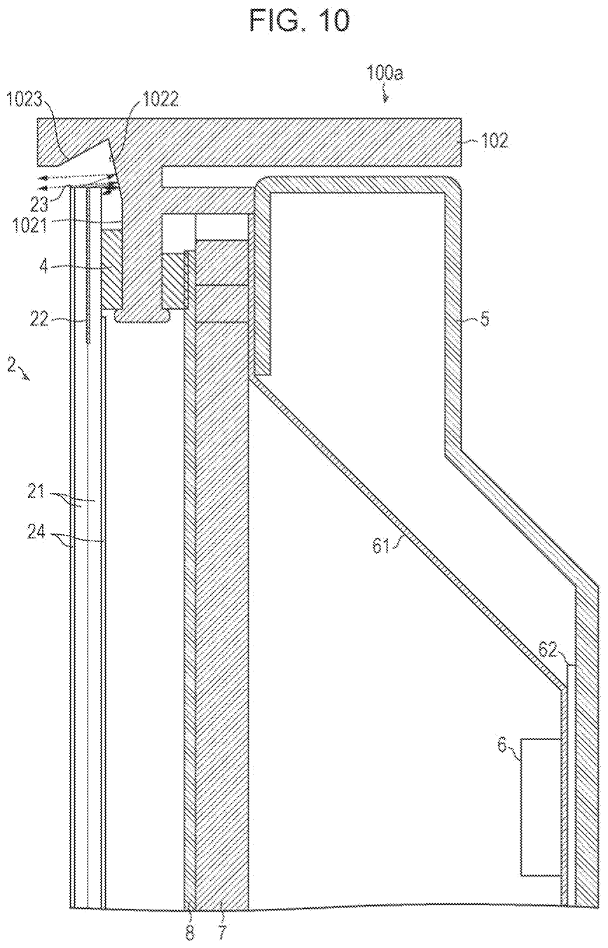

Leakage of light from the end face 23 can be suppressed even better through innovation of the form of the face of the frame 104 at the back side of the display panel 2. For example, as illustrated in FIG. 10, in the frame 102, there is concern that light traveling from the end face 23 to the rear face side as indicated by solid line arrows may be reflected by the second side face 1022, albeit only very slightly, and leak to the front face side of the display panel 2 as indicated by dotted line arrows.

Conversely, as illustrated in FIG. 8, light leaking from the end face 23, indicated by solid line arrows, is reflected toward the third side face 1043 by the fourth side face 1044 in the frame 104, as indicated by dotted line arrows. Accordingly, forming the fourth side face 1044 at an angle in the frame 104 enables light traveling to the rear face side from the end face 23 to be suppressed from leaking out to the front face side from between the end face 23 and the frame 104.

Note that the second side face 1042, the third side face 1043, and the fourth side face 1044 of the frame 104 may be treated so as to attenuate primary reflected light. For example, the surface of at least one of the third side face 1043 and the fourth side face 1044 of the frame 104 may be black. Also, the surface of the second side face 1042 may be black. Thus, light from the end face 23 is absorbed, thereby increasing the effect of suppressing leakage of light from the end face 23.

Also, the third side face 1043 may be formed as a recessed portion, with an end portion 1045 of the third side face 1043 at the front face side of the display panel 2 being located further toward the front face side than the display panel 2. According to this configuration, even in a case in which shrinkage of the frame 104 occurs, the end face 23 of the display panel 2 does not come into contact with the frame 104, due to the recessed portion formed by the third side face 1043. Accordingly, damage to the display panel 2 arising from contact between the frame 104 and the display panel 2 can be suppressed.

Modification 4

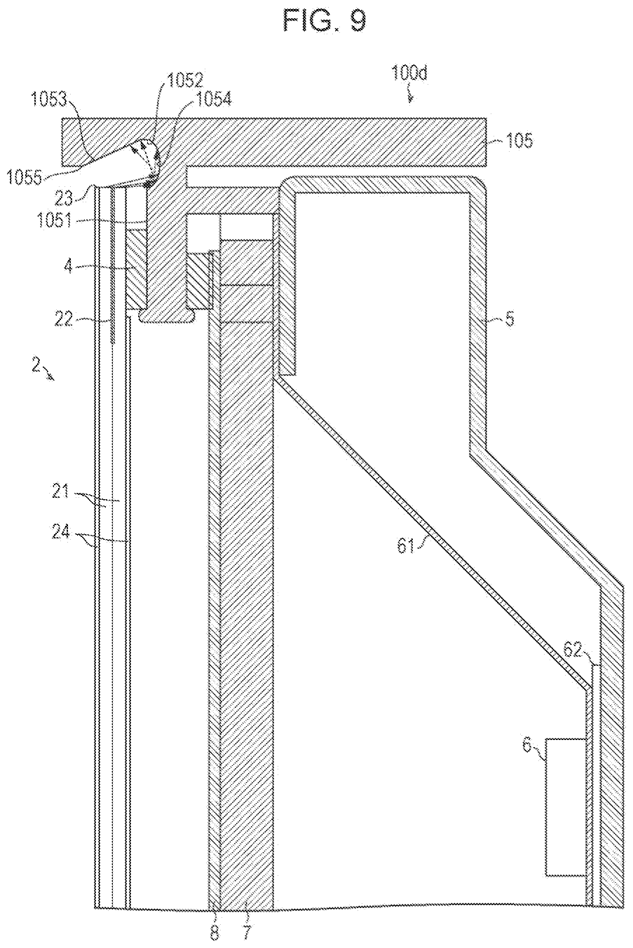

FIG. 9 is a cross-sectional view of a display device 100d that uses a frame 105 according to Modification 4. In detail, FIG. 9 is a cross-sectional view of the frame 105 and the surroundings thereof, taken along cross-sectional line IX-IX (dashed line) in FIG. 1. As illustrated in FIG. 9, the display device 100d includes the frame 105, the backlight chassis 5, the backlight 6, the diffusion plate 7, and the optical sheet 8. Other than using the frame 105 according to Modification 4, the display device 100d has the same configuration as the display device 100 that uses the frame 101.

Frame 105

The frame 105 has a first side face 1051, a second side face 1052, a third side face (first inclined face) 1053, and a fourth side face (second inclined face) 1054. The first side face 1051 is parallel to the faces of the display panel 2, and is formed so as to face the substrate 21 on the rear face side of the display panel 2. The substrate 21 on the rear face side and the first side face 1051 of the frame 105 are bonded by the light shielding double-sided tape 4.

The second side face 1052 is a side face connecting the third side face 1053 and the fourth side face 1054, and is parallel to the end face 23.

The third side face 1053 is formed at a position facing the end face 23 of the display panel 2, and is an inclined face of which the normal direction points toward the rear face side of the display panel 2. Also, the third side face 1053 is a planar inclined face.

The fourth side face 1054 is formed at the rear face side of the display panel 2, at a position away from the end face 23 of the display panel 2, and the normal direction thereof points toward the third side face 1053. Also, the fourth side face 1054 is a curved inclined face.

Note that the third side face 1053 may be formed as a recessed portion or may be formed as a protruding portion in the frame 105.

Also, the fourth side face 1054 may be formed as a recessed portion in the frame 105.

Leakage of light from the end face 23 can be suppressed even better through innovation of the form of the face of the frame 105 at the back side of the display panel 2. As illustrated in FIG. 9, in the frame 105, light leaking from the end face 23, indicated by solid line arrows, is reflected toward the third side face 1053 by the fourth side face 1054 as indicated by dotted line arrows. Accordingly, forming the fourth side face 1054 at an angle in the frame 105 enables light traveling to the rear face side from the end face 23 to be suppressed from leaking out to the front face side from between the end face 23 and the frame 105.

Note that the second side face 1052, the third side face 1053, and the fourth side face 1054 of the frame 105 may be treated so as to attenuate primary reflected light. For example, the surface of at least one of the second side face 1052, the third side face 1053, and the fourth side face 1054 of the frame 105 may be black. Thus, light from the end face 23 is absorbed, thereby increasing the effect of suppressing leakage of light from the end face 23.

Also, the third side face 1053 may be formed as a recessed portion, with an end portion 1055 of the third side face 1053 at the front face side of the display panel 2 being located further toward the front face side than the display panel 2. According to this configuration, even in a case in which shrinkage of the frame 105 occurs, the end face 23 does not come into contact with the frame 105, due to the recessed portion formed by the third side face 1053. Accordingly, damage to the display panel 2 arising from contact between the frame 105 and the display panel 2 can be suppressed.

Modification 5

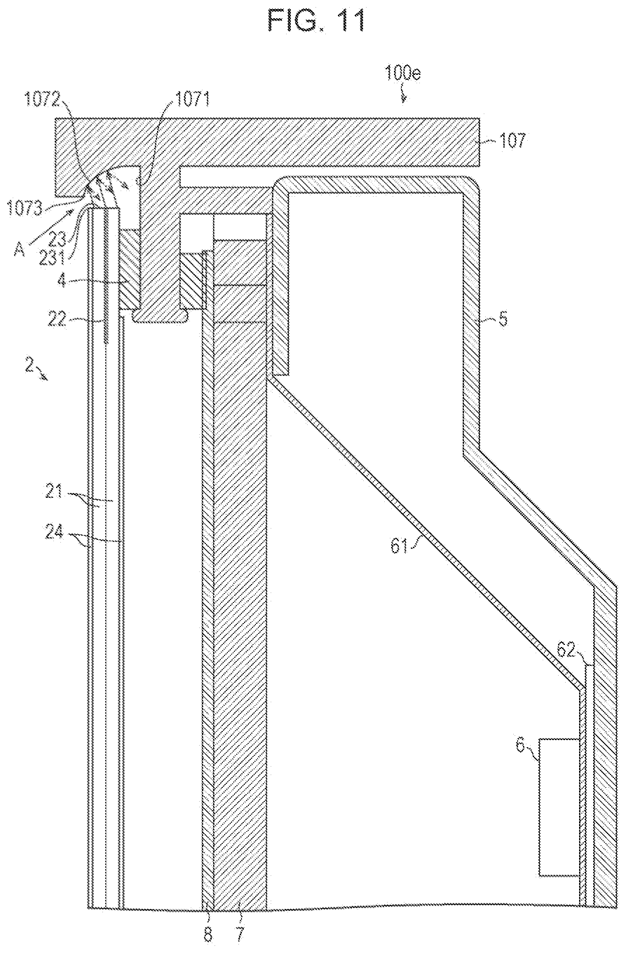

FIG. 11 is a cross-sectional view of a display device 100e that uses a frame 107 according to Modification 5. In detail, FIG. 11 is a cross-sectional view of the frame 107 and the surroundings thereof, taken along cross-sectional line XI-XI (dashed line) in FIG. 1. As illustrated in FIG. 11, the display device 100e includes the frame 107, the backlight chassis 5, the backlight 6, the diffusion plate 7, and the optical sheet 8. Other than using the frame 107 according to Modification 5, the display device 100e has the same configuration as the display device 100 that uses the frame 101.

Frame 107

The frame 107 has a first side face 1071 and a second side face (first inclined face) 1072. The first side face 1071 is parallel to the faces of the display panel 2, and is formed so as to face the substrate 21 on the rear face side of the display panel 2. The substrate 21 on the rear face side and the first side face 1071 of the frame 107 are bonded by the light shielding double-sided tape 4.

The second side face 1072 is formed at a position facing the end face 23 of the display panel 2, and is an inclined face of which the normal direction points toward the rear face side of the display panel 2. Also, the second side face 1072 is a curved inclined face. The second side face 1072 may be formed as a recessed portion in the frame 107.

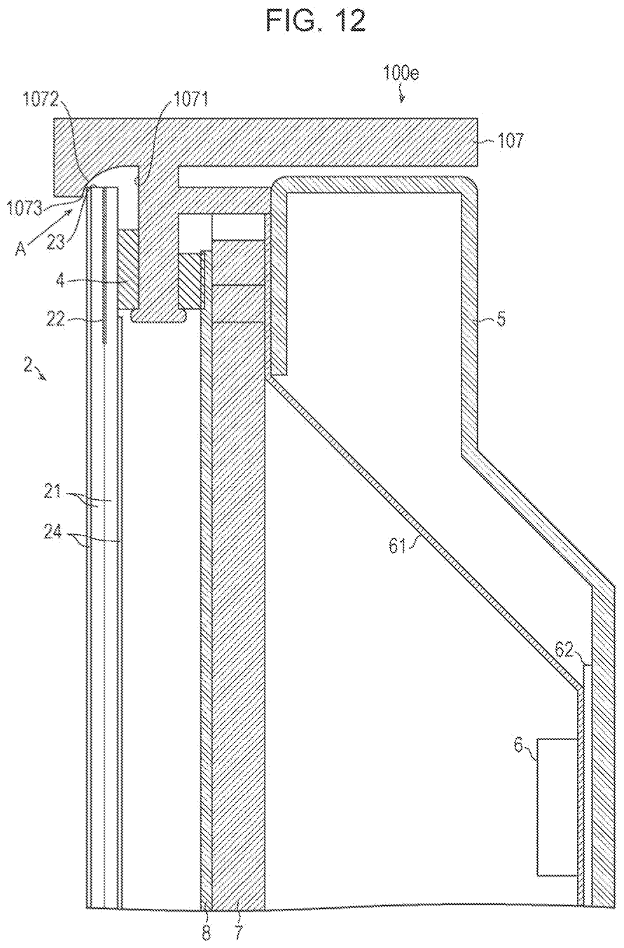

An end portion 1073 of the second side face 1072 at the front face side of the display panel 2 may be located further toward the front face side than the display panel 2. According to this configuration, as illustrated in FIG. 12, even in a case in which shrinkage of the frame 107 occurs, the end face 23 does not come into contact with the frame 107, due to the recessed portion formed by the second side face 1072.

Further, the position of the end portion 1073 of the second side face 1072 is near the position of the display panel 2 in a front-rear direction of the display panel 2. The front-rear direction of the display panel 2 is a direction from the front face of the display panel 2 toward the rear face thereof, and is a direction perpendicular to the faces of the display panel 2. According to this configuration, the gap between the end portion 1073 of the second side face 1072 and a front face side end portion 231 on the end face 23 of the display panel 2 is small and inconspicuous even when the display device 100e is viewed from the direction of an arrow A in FIG. 11, which is good from a design perspective.

Now, the phrase “the position of the end portion 1073 of the second side face 1072 is near the position of the display panel 2” indicates a state in which the distance in the front-rear direction of the display panel 2 between the end portion 1073 of the second side face 1072 and the surface of the display panel 2 on the front face side thereof is small. For example, the distance in the front-rear direction of the display panel 2 between the end portion 1073 of the second side face 1072 and the surface of the display panel 2 on the front face side thereof may be ½ the thickness of the display panel 2 or less. Note that the distance between the end portion 1073 of the second side face 1072 and the surface of the display panel 2 on the front face side thereof in the front-rear direction of the display panel 2 is preferably not more than 2 mm, and more preferably not more than 1 mm.

Also, the distance between the end portion 1073 of the second side face 1072 and the surface of the display panel 2 on the front face side thereof in the front-rear direction of the display panel 2 may be 0.2 mm or more. If the distance between the end portion 1073 of the second side face 1072 and the surface of the display panel 2 on the front face side thereof in the front-rear direction of the display panel 2 is within this range, contact between the display panel 2 and the frame 107 can be suppressed even in a case of the frame 107 shrinking, as illustrated in FIG. 12.

In FIG. 11, solid line arrows represent light leaking from the end face 23, and dotted line arrows represent light reflected by the second side face 1072. Light leaking from the end face 23 is reflected toward the rear face side of the display panel 2 by the second side face 1072. Because the frame 107 has a configuration including the second side face 1072, the frame 107 can suppress light from reflecting to the front face side of the display panel 2, and light can be suppressed from leaking out from between the display panel 2 and the frame 107.

Note that the second side face 1072 of the frame 107 may be treated so as to attenuate primary reflected light. For example, the surface of the second side face 1072 of the frame 107 may be black. Thus, light from the end face 23 is absorbed, thereby increasing the effect of suppressing leakage of light from the end face 23.

Display Devices According to other Embodiments

Note that a display device according to an embodiment is not limited to the above-described embodiment, as long as advantages of the present disclosure are obtainable. For example, it is sufficient for the structure of the display panel to be a structure that allows a frame to be disposed along the outer side thereof.

The forms of the first inclined face and the second inclined face may be adjusted as appropriate. For example, when the first inclined face and the second inclined face are formed on the frame as recessed portions, implementable forms may be employed for the forms of the recessed portions, taking into consideration the strength, thickness, material, external appearance, cost, and so forth of the frame.

Also, the number of first inclined faces is not limited in particular. For example, when a protruding portion is formed on the frame, the number of protruding portions may be one, or may be multiple.

The form of the second inclined face is not limited in particular, as long as the advantages described in the present specification can be obtained. Examples include a circular face, an elliptical face, an inclined face, and so forth.

The frame may be treated so as to attenuate primary reflected light. The type of treatment, and the portion where treatment is performed, are not limited in particular, and it is sufficient to perform treatment by which the advantages described in the present specification can be obtained.

The material of the frame is not limited to any particular material. Metal, resin, or the like may be used. As examples of materials, iron, aluminum, and so forth can be suitably used as metal, and polycarbonate (PC) and so forth can be suitably used as resin.

Summarization

A display device according to Form 1 of the present disclosure includes a display panel and a frame disposed along an outer edge of the display panel. The frame has a first inclined face, of which a normal direction points to a rear face side of the display panel, at a position facing an end face of the display panel.

According to the above configuration, light leaking from the end face of the display panel is reflected at the frame to the rear face side, and accordingly leakage of light to the front face can be suppressed.

In a display device according to Form 2 of the present disclosure, in the above Form 1, the first inclined face of the display device may be curved.

In a display device according to Form 3 of the present disclosure, in the above Form 1, the first inclined face of the display device may be planar.

In a display device according to Form 4 of the present disclosure, in any one of the above Forms 1 to 3, the first inclined face may be formed as a recessed portion in the frame.

In a display device according to Form 5 of the present disclosure, in the above Form 4, an end portion of the first inclined face at a front face side of the display panel may be located further toward the front face side than the display panel, and a position of the end portion of the first inclined face may be near a position of the display panel in a front-rear direction of the display panel.

In a display device according to Form 6 of the present disclosure, in any one of the above Forms 1 to 3, the first inclined face may be formed as a protruding portion on the frame.

In a display device according to Form 7 of the present disclosure, in any one of the above Forms 1 to 6, the frame may further have a second inclined face, of which a normal direction points to the first inclined face, at a position away from the end face of the display panel at the rear face side of the display panel.

In a display device according to Form 8 of the present disclosure, in the above Form 7, the second inclined face may be curved.

In a display device according to Form 9 of the present disclosure, in the above Form 7, the second inclined face may be planar.

In a display device according to Form 10 of the present disclosure, in any one of the above Forms 7 to 9, the second inclined face may be formed as a recessed portion in the frame.

In a display device according to Form 11 of the present disclosure, in any one of the above Forms 1 to 6, a surface of the first inclined face may be black.

According to the above configuration, primary reflected light can be attenuated, and thus leakage of light to the front face can be further suppressed.

In a display device according to Form 12 of the present disclosure, in any one of the above Forms 7 to 10, a surface of at least one of the first inclined face and the second inclined face may be black.

According to the above configuration, primary reflected light or secondary reflected light can be attenuated, and thus leakage of light to the front face can be further suppressed.

The present disclosure contains subject matter related to that disclosed in Japanese Priority Patent Application JP 2020-171966 filed in the Japan Patent Office on Oct. 12, 2020, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display panel; and
a frame disposed along an outer edge of the display panel,
wherein the frame has a first inclined face, of which a normal direction points to a rear face side of the display panel, at a position facing an end face of the display panel.

2. The display device according to claim 1,
wherein the first inclined face is curved.

3. The display device according to claim 1,
wherein the first inclined face is planar.

4. The display device according to claim 1,
wherein the first inclined face is formed as a recessed portion in the frame.

5. The display device according to claim 4,
wherein an end portion of the first inclined face at a front face side of the display panel is located further toward the front face side than the display panel, and a position of the end portion of the first inclined face is near a position of the display panel in a front-rear direction of the display panel.

6. The display device according to claim 1,
wherein the first inclined face is formed as a protruding portion on the frame.

7. The display device according to claim 1,
wherein the frame further has a second inclined face, of which a normal direction points to the first inclined face, at a position away from the end face of the display panel at the rear face side of the display panel.

8. The display device according to claim 7,
wherein the second inclined face is curved.

9. The display device according to claim 7,
wherein the second inclined face is planar.

10. The display device according to claim 7,
wherein the second inclined face is formed as a recessed portion in the frame.

11. The display device according to claim 1,
wherein a surface of the first inclined face is black.

12. The display device according to claim 7,
wherein a surface of at least one of the first inclined face and the second inclined face is black.
